(19) United States
(12) Patent Application Publication
(10) Pub. No.: US 2004/0227337 A1
(43) Pub. Date: Nov. 18, 2004

(54) Inflation device for a vehicle occupant restraint system

(75) Inventors: Rolf Ruckdeschel, Schwangau (DE); Achim Hofmann, Polling (DE); Anja Esau, Ampfing (DE)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: TRW Alrbag Systems GmbH

(21) Appl. No.: 10/797,419

(22) Filed: Mar. 10, 2004

(30) Foreign Application Priority Data
Mar. 11, 2003 (DE) 203 03 836.3

(51) Int. Cl. B60R 21/26

(52) U.S. Cl. 280/736

(57) ABSTRACT

An inflation device (10) for a vehicle occupant restraint system comprises a first pyrotechnic gas generator (12) having a cord-type fuel line (20) and an igniter (18) associated with the fuel line, and a second pyrotechnic gas generator (14) having a housing (30) and fuel elements (32) arranged in the housing (30). The cord-type fuel line (20) is passed through the housing (30) of the second pyrotechnic gas generator (14) and is adapted to release combustion products for igniting the fuel elements (32) of the second gas generator.

### FIELD OF THE INVENTION

The invention relates to an inflation device for a vehicle occupant restraint system comprising a first pyrotechnic gas generator, which has a cord-type fuel line and an igniter associated with the fuel line, and a second pyrotechnic gas generator having a housing and fuel elements arranged in the housing.

### BACKGROUND OF THE INVENTION

Inflation devices with a cord-type fuel line are used everywhere where a particularly rapid generation of gas is to take place. Such an inflation device is shown, for example, in DE 41 34 995 C1 disclosing a side impact protection system for occupants of a motor vehicle, in which a cord-type fuel line generates gas directly at the required site and thereby avoids time-consuming flow processes. Such systems have the short reaction times necessary in a side impact. Inflation devices with cord-type fuel lines can spread over areas of any desired shape, whereby a very good adaptation of side impact protection systems to the spatial conditions in a motor vehicle is possible.

In addition, it has already been proposed to use gas generators having cord-type fuel lines in combination with further pyrotechnic gas generators. These combinations are used when the gas is to be released over a longer period of time than the combustion period of the cord-type fuel line. DE 101 46 458 A1 discloses such a combination of a gas generator with a cord-type fuel line (cord-type gas generator) and of a second pyrotechnic gas generator with conventional fuel elements, the second pyrotechnic gas generator being connected with the cord-type gas generator by a connecting channel.

As in such a combination of gas generators the combustion products released by the cord-type fuel line of the first pyrotechnic gas generator are largely gaseous, under these circumstances they can cool down to such an extent that the second pyrotechnic gas generator can no longer be reliably ignited with the fuel elements. DE 101 46 458 A1 therefore also proposes an ignition amplification with a booster charge arranged at the connecting channel.

### SUMMARY OF THE INVENTION

According to the invention, there is provided an inflation device, which is simply constructed and able to be produced at a favourable cost, for a vehicle occupant restraint system with two combined pyrotechnic gas generators of the type initially described, which is characterized in that the cord-type fuel line is passed through the housing of the second pyrotechnic gas generator, the cord-type fuel line and the fuel elements being associated with each other so that the ignition of the fuel elements of the second pyrotechnic gas generator takes place through combustion products released by the cord-type fuel line of the first pyrotechnic gas generator.

The combustion products released by the section of the cord-type fuel line situated in the housing of the second pyrotechnic gas generator can therefore act quickly on the fuel elements of the second pyrotechnic gas generator which are in the immediate vicinity, and can ignite these without delay. Thereby, it is additionally achieved that the igniter of the inflation device ignites in a cascade firstly the cord-type gas-generating fuel line, and then, through the hot gases released therefrom, the fuel elements surrounding the fuel line are activated.

Within the meaning of the invention, cord-type fuel lines are those which have a length to diameter ratio of approximately ≧50, particularly preferably ≧100.

In an embodiment of the invention, the first pyrotechnic gas generator (cord-type gas generator) has a continuous housing of a pressure-resistant material, which passes through the housing of the second gas generator. In the housing of the cord-type gas generator, openings are provided for the outlet of gas, which are in flow connection with the inflation device. In its section passing through the housing of the second gas generator, the housing of the cord gas generator has overflow openings providing a fluid connection between the first and the second gas generator or respectively the cord-type fuel line and the fuel elements, so that on the one hand the combustion products released from the fuel line pass through the overflow openings and can ignite the fuel elements of the second pyrotechnic gas generator, and on the other hand the gases released thereafter from the fuel elements can be passed via the overflow openings and the gas outlet openings to the inflatable safety device, for example a gas bag.

In a further embodiment, the housing of the cord-type gas generator only surrounds the cord-type fuel line outside the second pyrotechnic gas generator. That is, the housing of the cord-type gas generator adjoins the housing of the second pyrotechnic gas generator, and the cord-type fuel line, passing through this housing is in direct connection with the fuel elements of the second gas generator. The combustion products released from the section of the cord-type fuel line situated in the housing of the second gas generator therefore act directly on the fuel elements of the second pyrotechnic gas generator.

The fuel elements can be fuel tablets of known shape and dimensions, which are arranged in a fill. This fill can directly surround the cord-type fuel line and touch it. Thereby, the released combustion products can neither cool down nor lose energy elsewhere, until they reach the fuel tablets.

In a further preferred embodiment, the fuel elements in the second pyrotechnic gas generator can also be of hollow cylindrical shape and the fuel line can be passed through the cylinder cavity, so that each hollow cylindrical fuel element surrounds the cord-type fuel line peripherally. As the combustion products of the cord-type fuel line are generally emitted radially outwards in all directions, in this embodiment they must strike against the inner side of the hollow cylindrical fuel elements and necessarily ignite them.

Most preferably, the fuel elements have a substantially longer combustion time than the cord-type fuel line. In this way, the fuel elements of the second pyrotechnic gas generator additionally provide gas to operate the inflation device, wherein the service life of an airbag being considerably increased compared with embodiments with pure cord-type gas generators.

### BRIEF DESCRIPTION OF THE DRAWINGS

Further advantages of the invention will be apparent from the following description of preferred embodiments with reference to the drawings. In the drawings:

FIG. 1 shows a cross-section through a first embodiment of an inflation device according to the invention, and

FIG. 2 shows a section through a second embodiment of the inflation device according to the invention.

### DETAILED DESCRIPTION OF PREFERRED EMBODIMENTS OF THE INVENTION

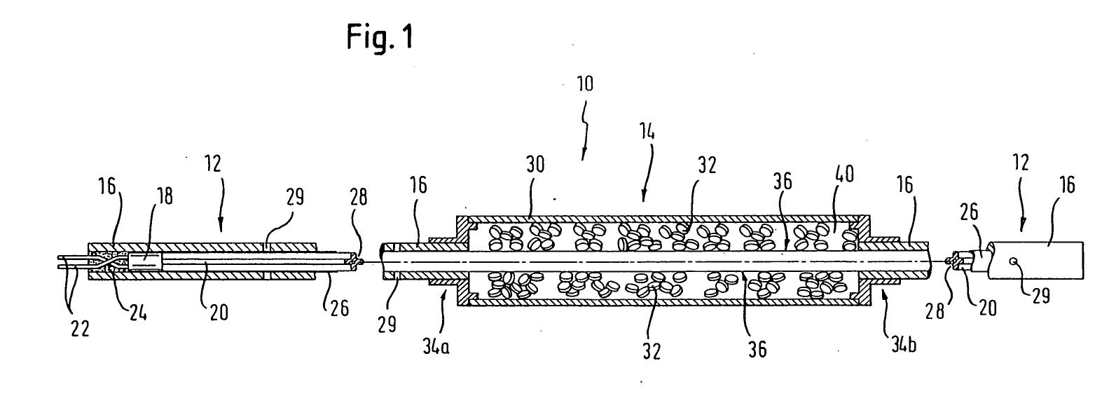

The preferred embodiment of an inflation device 10, illustrated in FIG. 1, comprises a first pyrotechnic gas generator 12 and a second pyrotechnic gas generator 14.

The first pyrotechnic gas generator 12 has a housing 16, preferably of a pressure-resistant material, as well as an igniter 18 and a cord-type fuel line 20 associated to and adjoining the igniter, for the generation of gases, which are arranged in the housing. The igniter 18 has two connecting pins leading outwards of the housing, and is sealed towards the exterior by a moisture barrier 24. Between the igniter 18 and the cord-type fuel line 20 on the one hand and the first housing 16 on the other, there is also a sealing layer 26, which likewise is intended to prevent an action of moisture on the cord-type fuel line. The cord-type fuel line 20 has a cruciform cross-section, whereby passage channels 28 are formed in longitudinal direction of the first pyrotechnic gas generator 12. In the housing 16, openings 29 are arranged for the outlet of gas, which are in flow connection with a gas bag (not shown) arranged after the inflation device 10.

The second pyrotechnic gas generator 14 is arranged on any desired longitudinal section of the first gas generator 12 and has a second, preferably closed, housing 30, which delimits a fuel chamber 40 in which fuel elements 32 are arranged. The second housing 30 is securely connected with the first housing 16 in connecting regions 34a and 34b at opposing sides of the second housing 30 in a suitable manner, e.g. by welding, soldering or glueing. The distance between the connecting region 34a and the connecting region 34b defines a contact section 36 between the first pyrotechnic gas generator 12 or respectively the cord-type fuel line 20 and the second pyrotechnic gas generator 14 or respectively the fuel elements 32, in which the cord-type fuel line is passed through the housing 30.

In the embodiment illustrated in FIG. 1, the second pyrotechnic gas generator 14 in the contact section 36 completely surrounds the periphery of the first pyrotechnic gas generator. The housing 16 of the first pyrotechnic gas generator 12 adjoins the housing 30 of the second pyrotechnic gas generator 14, whereas the fuel line 20 enters the housing 30 in the connecting region 34a, passes through the housing 30 in the contact section 36, and leaves the housing 30 of the second gas generator 14 at the connecting region 34b. The cord-type fuel line 20 therefore does not have its own housing in the contact section 36, but is in direct contact with the fuel elements 32, which are preferably provided as fuel tablets and are arranged in a fill. Optionally, the sealing layer 26 can be constructed as a thin aluminium foil or as composite material on the basis of aluminium and plastic, and can also surround the fuel line in the contact section 36. Thereby, the mechanical stability of the fuel line can be improved.

The mode of operation of this embodiment of the inflation device is described below:

As soon as a sensor arranged in the vehicle detects a vehicle accident, an electrical signal reaches the igniter 18 via the connecting pins 22.The igniter 18 generates a gas pressure wave which is passed on in the passage channels 28 formed by the cruciform fuel line 28 along the entire cord-type gas generator. Thereby, the cord-type fuel line 20 is ignited very quickly everywhere on its surface, i.e. within a few milliseconds. The gases released from the cord-type fuel line 20 can for example flow into a gas bag arranged thereafter, via the gas outlet openings 29 and inflate the gas bag in the required short space of time.

In the contact section 36, the combustion products released by the cord-type fuel line 20 directly activate the fuel elements 32 in the second gas generator. The activated fuel elements 32 release a very large amount of gas, which—as the housing of the second gas generator is closed and does not have any gas outlet openings—likewise flows off via the gas outlet openings 29 in the cord-type gas generator and provides for the airbag arranged thereafter (not illustrated) being supplied with gas over a longer period and remaining inflated. The gas is therefore not only provided for a few milliseconds (typically <10 ms) solely by the cord-type fuel line, but is produced over a period of up to several seconds. Through the extension of the service life of the inflated airbag, resulting therefrom, its protective effect is distinctly improved, in particular in accident situations, in which the vehicle occupant requires protection by the airbag several times within a certain period of time.

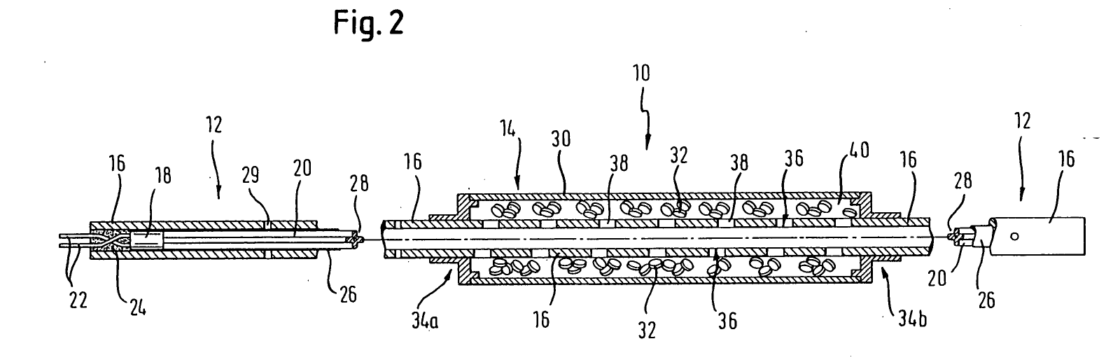

FIG. 2 shows in a further embodiment the inflation device 10 with the two pyrotechnic gas generators 12 and 14, wherein parts having like functions being given like reference numbers. The inflation device according to FIG. 2 is largely constructed in the same manner as the first embodiment, the cord-type fuel line 20, however, also being surrounded over the distance of the contact section 36 by the first housing 16, preferably of pressure-resistant material. In the contact section 36, the first housing 16 has overflow openings 38 through which, after the activation of the first gas generator, a fluid connection exists between the cord-type fuel line 20 and the fuel chamber 40. In this embodiment, the fuel line is better protected with respect to mechanical stresses.

The mode of operation of the second embodiment is similar to that of the first embodiment.

After activation of the igniter 18, a pressure wave runs along the entire cord-type fuel line 20, after which the latter is ignited. The combustion products released by the cord-type fuel line 20 pass over in the contact section 36 through the overflow openings 38 into the fuel chamber 40, whereby the fuel elements 32 are activated. The gases released by the fuel elements 32 pass via the overflow openings 38 and the gas outlet openings 29 out from the gas generators 12, 14, to arrive into an inflatable vehicle occupant protective device (not illustrated), for example a gas bag.

Also in this embodiment, the service life of the gas bag is distinctly increased. Whereas the cord-type fuel line 20 is generally combusted after a few milliseconds, the combustion duration of the fuel elements 32 amounts to up to several seconds, so that the gas bag can also support a multiple vehicle occupant impact.

1. An inflation device (10) for a vehicle occupant restraint system comprising a first pyrotechnic gas generator (12) having a cord-type fuel line (20) and an igniter (18) associated with the fuel line, and a second pyrotechnic gas generator (14) having a housing (30) and fuel elements (32) arranged in the housing (30), wherein the cord-type fuel line (20) passes through the housing (30) of the second pyrotechnic gas generator (14) and wherein the cord-type fuel line (20) within said housing (30) is adapted to release combustion products for igniting the fuel elements (32) of the second gas generator.

2. The inflation device according to claim 1, wherein the first pyrotechnic gas generator has a housing (16) with overflow openings (38), through which combustion products released from the fuel line (20) pass, and wherein the housing (16) of the first pyrotechnic gas generator (12) with the overflow openings (38) passes through the housing (30) of the second pyrotechnic gas generator (14).

3. The inflation device according to claim 1, wherein the first pyrotechnic gas generator (14) has a housing (16) adjoining the housing (30) of the second pyrotechnic gas generator (14), and wherein the fuel line (20) passing through the housing (30) of the second gas generator (14) being directly in contact with the fuel elements.

4. The inflation device according to claim 1, wherein the fuel elements (32) are fuel tablets which are arranged in a fill.

5. The inflation device according to claim 1, wherein the fuel elements (32) are of hollow cylindrical shape and each hollow cylindrical fuel element (32) surrounds the fuel line (20) peripherally within the housing (30) of the second pyrotechnic gas generator (14).

6. The inflation device according to claim 1, wherein the fuel elements (32) have a higher combustion rate than the fuel line (20).
